(19) United States
(12) Patent Application Publication
(10) Pub. No.: US 2004/0157198 A1
(43) Pub. Date: Aug. 12, 2004

(54) Multiplication learning device

(75) Inventor: Douglas Andrew Hill, Huntington Beach, CA (US)

Correspondence Address: DOUGLAS ANDREW HILL, 21562 SURVEYOR CIRCLE, HUNTINGTON BEACH, CA, 92646, US

(73) Assignee: Douglas Andrew Hill, Huntington Beach, CA

(21) Appl. No.: 10/248,700

(22) Filed: Feb. 10, 2003

(51) Int. Cl. G09B 5/00

(52) U.S. Cl. 434/201

(57) ABSTRACT

A device that can be held in your hand and is designed to teach and enforce the concept of multiplication to children. The device enables the child to visualize a multiplication problem. The device is designed so that by selecting a number of rows and columns, their product will appear. Their product appears at the intersection of these rows and columns. In our preferred embodiment this is accomplished with a square plastic base containing holes. If you have five rows and five columns, you would have 25 holes. Five rods are inserted for the columns and five rods are inserted for the rows in two sides of the base. The rods pass at 90 degrees to each other in the holes. Marbles are placed in the holes and are supported by the rods. A marble is supported by both the row rod and column rod. When both the row rod and column rod are removed, the marble will fall. Thus, if you remove two row rods and three column rods, six marbles will fall (2×3=6). The six marbles fall into a tray. The tray has 25 indents corresponding to the holes. When the marbles fall, they fall into these indents and are held in place. For this example, when you lift up the base you would see six marbles still in the position where they dropped from where the row and column rods intersect.

### BACKGROUND OF THE INVENTION

1. Field of the Invention

This invention relates to a multiplication learning aid device for visually and kinesthetically teaching and enforcing multiplication concepts. The device also reinforces addition and other mathematical concepts.

2. Description of the Prior Art

Educators have devised and tested many methods and techniques for teaching multiplication and/or multiplication tables to students. Examples include typed or printed sheets of the multiplication tables, display cards with the equation printed on one side and the answer on the opposite side, and lots of multiplication worksheets. Such techniques are generally very tedious and boring to the student. Mental enforcement of the multiplication tables is usually accomplished only after long and repeated use of these techniques. Further, with these techniques, even after students memorize the multiplication tables they may lack a basic understanding of the multiplication process. They also are given calculators to find the answer to multiplication problems. This further removes them from an understanding (or even a need to understand) the multiplication process. Parents are left with few options for teaching multiplication at a young age to their child, and the options that do exist are inappropriate. The methods of teaching multiplication also rely on a child's understanding of the written number, which limits the age at which a child can be taught. Accordingly, there is an obvious need for a simple training device that will enable children to be taught early the multiplication process in a fun and expeditious manner. This device will make the learning of the multiplication tables instinctual and fun, instead of a memorization process. As with a language there is a need to teach these concepts early, so they will be incorporated into a child's natural thinking pattern.

### SUMMARY OF INVENTION

The present invention provides a unique and simple learning device for teaching a child multiplication. The use of the device provides the child with both a visual and kinesthetic feedback; which helps them to visualize the multiplication process, and have fun while they are doing it.

With this device the problem can be put into a form that a child can understand, without the need for an understanding of the written number. How many marbles will fall out when I pull two rows and three columns? Even when they don't know the answer, they can find it out by simply performing the operation, and then counting the marbles.

A further feature of the present invention provides a multiplication learning aid device which is easy for a child or instructor to use.

Furthermore, an additional feature of the present invention provides a multiplication learning aid device which will enhance the interest and stimulate a student's understanding in learning the multiplication process.

Yet still another feature of the device is that a young child can use it like a calculator when filling in a multiplication work sheet. All they need to know is how to count. Other features of this invention will be apparent during the course of the following description. This device also allows for teaching of the multiplication process at a much earlier age.

### BRIEF DESCRIPTION OF DRAWINGS

The accompanying figures are part of this specification.

FIG. 1 is a top view of the multiplication learning device, with the rods and marbles. The picture also includes its tray.

FIG. 2 is a top view of the multiplication learning device, with the rods and marbles. Column rods 2,3,4 and row rods 1,2 are extended. Marbles 2,3,4,7,8, and 9 have dropped down.

FIG. 3 is a top view of the learning device tray, with marbles 2,3,4,7,8, and 9 sitting in indents on the tray.

FIG. 4 is a top view of the multiplication learning device, with the rods and marbles. Column rods 3,4,5 are removed. Marbles 16, and 21 are removed

FIG. 4a is a close up view of a holes 16, and 21 and where the rods cross to support marbles 16, and 21.

FIG. 5 is a top view of the multiplication learning device using lights and switches instead of rods and marbles.

### DETAILED DESCRIPTION

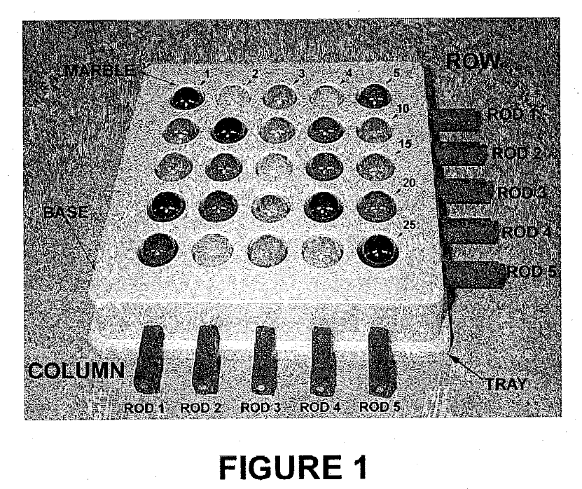

Referring now to the pictures in detail, there is shown a preferred form of the multiplication learning device constructed in accordance with the principles of the present invention in FIG. 1 and which is comprised of a base, a tray, five row rods, five column rods, and 25 marbles.

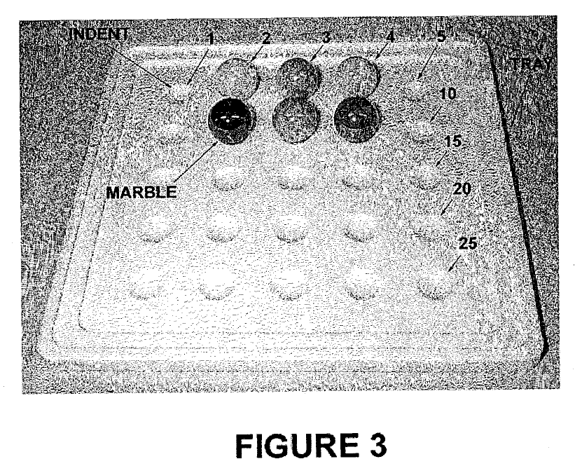

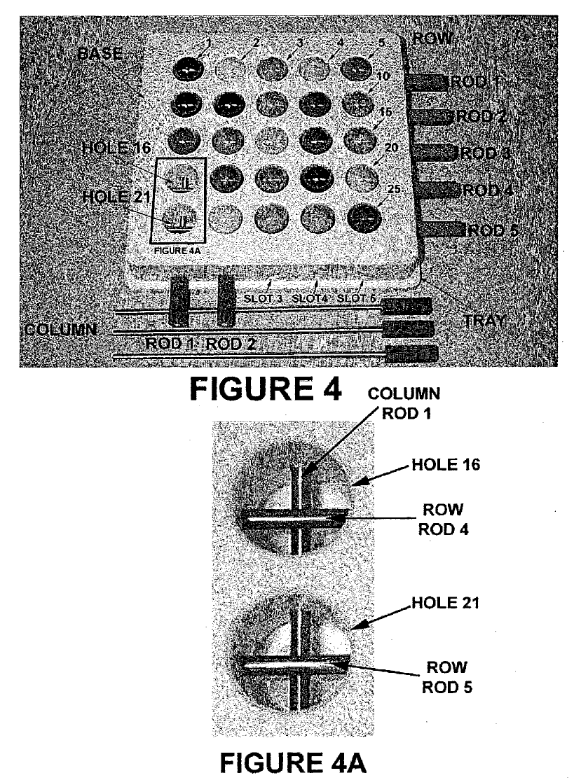

The base and tray are constructed of durable material, such as plastic or wood, and is square (or rectangular) in configuration. The base has 25 holes, which the marbles can drop through (see FIG. 1, 2, 3). It also has five row slots, and five column slots which the rods slide into (see FIG. 4, 4a). The tray has small indents for the marbles to rest on (see FIG. 3). The key to the design is that slots are cut into base so that row and column rods can be inserted and pass into each hole. These rods support the marbles. Only when both rods are removed will a marble fall (see FIG. 4, 4a).

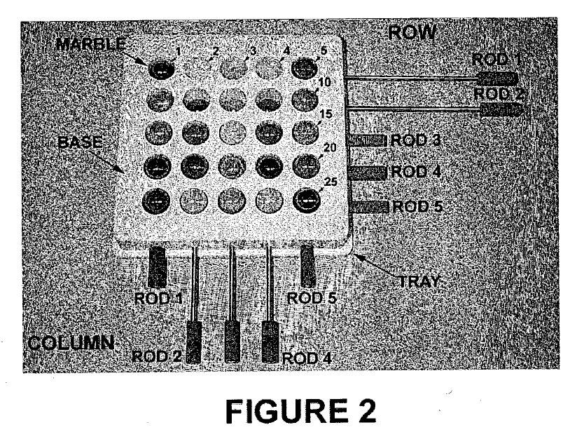

In operation, the child, and adult would start with the multiplication device as shown in FIG. 1. This means row rods one to five are inserted, column rods one to five are inserted, the 25 marbles are in their holes, and it is resting on its tray. The adult would ask the child to guess how many marbles will fall out if we pull two row rods, and three column rods? The child would make his/or her guess and then proceed to test it out with the multiplication device. The child would pull row rods 1,2 and column rods 2,3,4 (which row and column rods they select is not critical). Marbles 2,3,4,7,8,9 drop down into tray (see FIG. 2). The child would then lift the base up and count the marbles that dropped into the tray. A small child often takes the marbles out and counts them one at a time (see FIG. 3).

There is thus provided a unique multiplication learning device which provides an effective visual and kinesthetic aid for teaching multiplication to a child and it enables them to visualize how numbers expand during the multiplication process, thereby reinforcing the concept of multiplication within the students minds for a better understanding and easier retention.

It is to be understood that the form of this invention as shown and described is to be taken as a preferred example thereof, and that this invention is not to be limited to the exact arrangement of parts described in the description or illustrated in the pictures as changes thereto in the details thereof pertaining to size, shape, number and arrangement of parts thereof are envisioned within the scope of the invention without departing from the novel concepts of the invention. For example you could have selected ten rows with ten columns, and a hundred plastic beads. This would allow you to do 10×10=100.

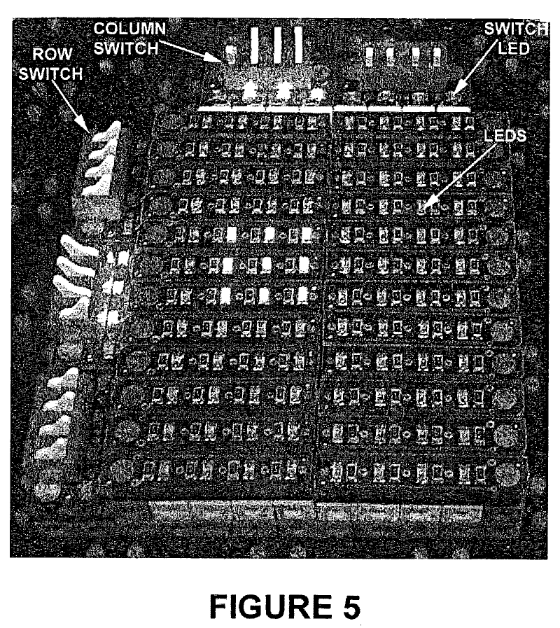

A second preferred form is also shown in FIG. 5. It utilizes a product that I developed called Snap Circuits. Here, the multiplication machine is made with electronics. Instead of row and column rods, we have switches. Instead of marbles, we have LEDs (light emitting diodes). In this embodiment, we have eight column switches, twelve row switches, 96 product LEDs, eight column switch LEDs, twelve row switch LEDs, and additional support components (FIG. 5). If a student wanted to see what 3 times 3 was, he would simply toggle 3 row switches and three column switches and count how many LEDs light up. This example is shown in FIG. 5.

1. I claim a multiplication learning aid device that can be held in your hand, where you can select two numbers, which can be physically counted. The product of these numbers is physically displayed, and can also be counted.

2. [I claim a device as described in claim 1,] Where the two numbers are arranged in a row and column format. Where the product of those numbers is shown at the intersection of the rows and columns.

3. I claim a multiplication learning aid device for teaching multiplication and mentally reinforcing the concepts of multiplication, addition, and mathematics to a student or child. The device comprising, in combination:
A plastic base with holes, column rods, row rods, and marbles. The base contains holes large enough for the marble to pass through. The base contains slots for the rods. The holes are at the intersection of the rows and columns. The row and column rods pass through the hole such that they support the marbles. When the rods are removed, the marbles drop and can be physically counted in your hand. So, if you remove two row rods and three column rods, six marbles will fall. The material suggested is not critical. Instead of marbles, plastic beads could be used to reduce cost etc.

4. [I claim a device as described in claim 3,] Including a tray. This tray would be used to catch the marbles. The tray could include indents so the marbles position would be held. This helps the student see the relationship between selected rows, columns, and marbles that drop.

5. I claim a multiplication learning aid device for teaching multiplication and mentally reinforcing the concepts of multiplication, addition, and mathematics to a student or child. The device comprising, in combination:
Matrix of lights (or light emitting diodes), row buttons (or switches) and column buttons (or switches). The column buttons would be placed horizontally and the row buttons would be placed vertically. The lights would be placed at the intersection of rows and columns. When the 3 row buttons are pushed, and two column buttons are pushed, six lights would light. This device functions in much the same way as the device in claim 3, except that instead of marbles that you count in your hand, you have lights, and instead of rods that you pull out, you have buttons (or switches).
